(19) United States
(12) Patent Application Publication
(10) Pub. No.: US 2003/0005788 A1
(43) Pub. Date: Jan. 9, 2003

(54) Transversely moving cable control

(76) Inventor: William Bolick, Pleasant Grove, UT (US)

Correspondence Address: FEHR LAW FIRM, Suite 300, Goldenwest Corporate Center, 5025 Adams Avenue, Ogden, UT, 84403, US

(21) Appl. No.: 10/078,078

(22) Filed: Feb. 15, 2002

Related U.S. Application Data
(63) Continuation of application No. 08/902,987, filed on Jul. 30, 1997, now abandoned.

(51) Int. Cl. F16C 1/10

(52) U.S. Cl. 74/502.2

(57) ABSTRACT

A transversely moving cable control for operating devices such as the brakes or gear shift of a bicycle. In one embodiment a lever is rotatably attached to a hollow base plate. Rotation of the lever away from the base plate transversely moves the portion of a cable between a cable guide in the base plate and an exit aperture in the lever to create a pulling force on one or both ends of the cable. Meanwhile, the cable guide and the exit aperture maintain the portion of the cable outside the transversely moving cable control in substantially the original position of such cable. An alternate embodiment accomplishes these same functions by using a substantially U-shaped housing having cable guides in the ends of the legs of such housing to maintain the outer portions of the cable in substantially their original position while employing a pulley inside a block that is drawn toward an aperture in the second end of the U-shaped housing to transversely move the intermediate portion of the cable.

### CROSS-REFERENCE TO RELATED APPLICATION

This is a continuation of copending U.S. application Ser. No. 08/902,987, filed on Jul. 30, 1997.

### BACKGROUND OF THE INVENTION

1. Field of the Invention

This invention relates to a control for transversely moving cables, especially those cables which operate such devices as the brakes on a bicycle.

2. Description of the Related Art

There are many patented systems for controlling a cable to operate devices on a bicycle.

A significant number of these patents apply to devices which simply pull the cable from one end to exert a pulling force to control a device connected to the other end of the cable. Examples of this type of control are found in U.S. Pat. Nos. 2,560,154; 4,005,613; and 5,584,210.

Also, a substantial number of patents cover devices which utilize a second cable to pull at an intermediate point on a first cable to create pulling forces on both ends of the first cable. To this category belong U.S. Pat. Nos. 4,026,390 and 4,143,745; the embodiment represented by FIG. 8 in U.S. Pat. Nos. 4,653,613; and 5,564,531 and 5,582,272. None of these patents, however, employ devices to maintain the first cable (at points other than the area where the second cable acts and the ends of such first cable) in substantially the original position of such first cable.

U.S. Pat. No. 4,245,522 simply has a first lever connected by a first cable to a second lever which is connected to the cable which leads to the device to be operated. Moving either lever will then pull on a first end of the cable leading to the device to be operated by the consequent pull by the second end of such cable.

The control invention of United States Pat. No. has a lever at each upper end of a Y-shaped cable so that using either lever to pull its associated segment of the cable will create a pull at the bottom of the cable to operate a device.

A sheath designated an “outer cable” covers an “inner cable” in the invention of U.S. Pat. No. 4,901,595. At an intermediate point the sheath is divided perpedicularly to its length. The divided segment nearer the device to be controlled is held in place while the other segment is rotated away from the segment nearer the device, thereby pulling on the inner cable and creating a pull on the end of the cable which operates a device.

Finally, the invention of U.S. Pat. No. 5,540,304 utilizes a first cable attached by a first pulley to a lever in order to move such lever and thereby to create a mechanical advantage by moving a second pulley that is attached to the lever at a position farther from the pivot point than is the first pulley. This second pulley then pulls on a second cable at an intermediate point. The segments of the second cable must, however, be parallel to one another as they depart from the second pulley.

### SUMMARY OF THE INVENTION

The Transversely Moving Cable Control, as its name implies, creates a pull on one or both ends of a cable by exerting a force transverse to the path of the cable while maintaining the cable (at points other than the area where the second cable acts and the ends of the cable) in substantially the original position of the cable.

Such transverse movement, consequently, causes at least one end of the cable to be drawn longitudinally closer to the Transversely Moving Cable Control, just as in the case of the control systems of the prior art. And allowing the cable to move transversely closer to its original path permits such end of the cable to move farther from the Transversely Moving Cable Control since the cable—when the lever has been moved from its original (rest) position—traditionally has some force acting longitudinally along the cable in the direction opposite to the movement caused by the transverse movement of the cable away from its original path. Again, the resultant effect is the same as that achieved with a traditional control system.

Since the activating force for a device is not created by pulling one end of the cable, the Transversely Moving Cable Control can be position either at an end of the cable or at an intermediate position along the cable.

Moreover, no outer cable or sheath is necessary; and the segments of the cable do not have to be parallel to one another as such segments depart the Transversely Moving Cable Control.

And the mechanical advantage of the Transversely Moving Cable Control can be made adjustable.

### BRIEF DESCRIPTION OF THE DRAWINGS

FIG. 1 illustrates an embodiment of the Transversely Moving Cable Control which differs from the preferred embodiment only in the fact that the pivot for the pulley that transmits the transverse force to the cable is not adjustable.

FIG. 2 shows the preferred embodiment for the Transversely Moving Cable Control.

FIG. 3 depicts an alternate embodiment of the Transversely Moving Cable Control.

FIG. 4 portrays the embodiment of FIG. 1 where a first end of the cable has been anchored just beyond the exit aperture of the lever.

### DESCRIPTION OF THE PREFERRED EMBODIMENT

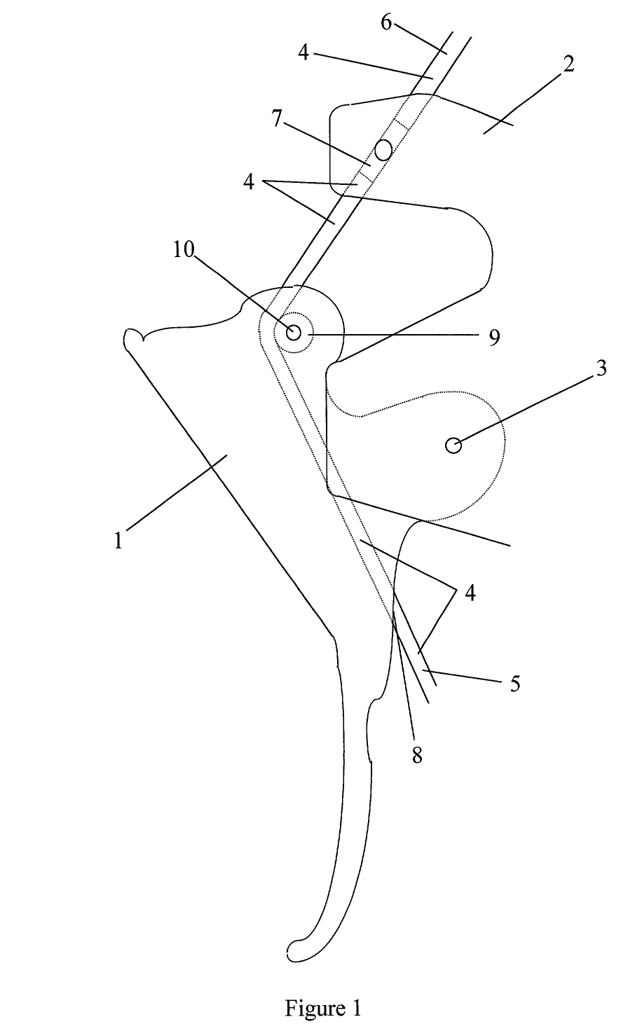

As illustrated in FIG. 1, the Transversely Moving Cable Control has a lever 1 rotatably attached to a hollow base plate 2 with a pivot 3.

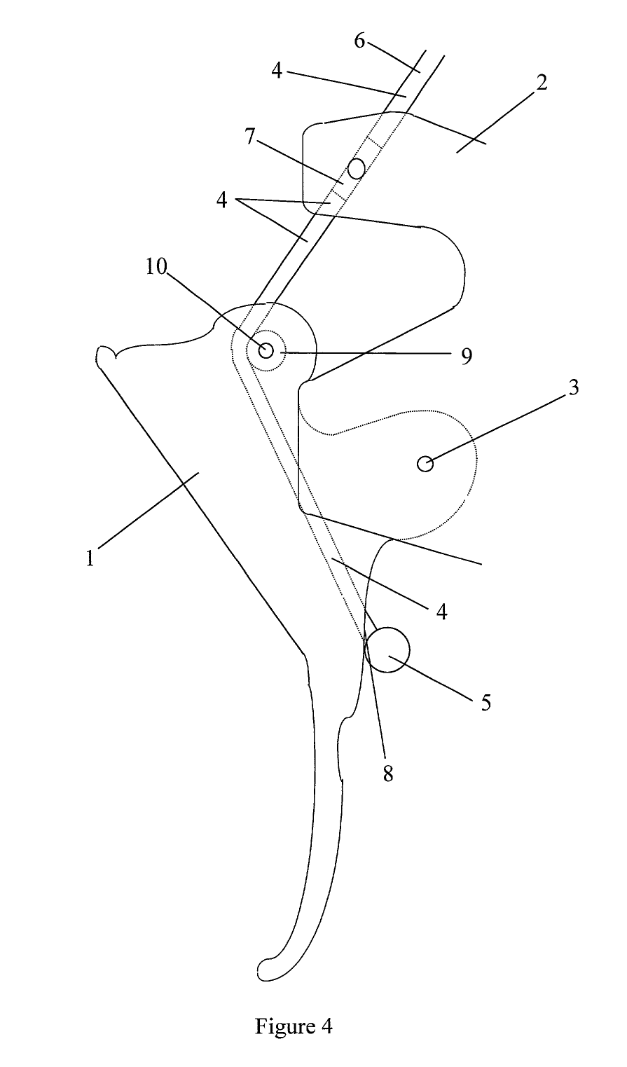

When the lever 1 has been rotated into the base plate 2 to the maximum extent possible, the cable 4 follows its original path. As the lever 1 is rotated outward from the base plate 2, the cable 4, between a cable guide 7 and an exit 8 from the lever 1, i.e., the portion of the cable 4 which is within the transversely moving cable control, is moved substantially transversely to the original path of the cable 4, preferably by a pulley 9 attached to the lever 1 across which pulley 9 the cable 4 runs, although a simple projection would suffice for this purpose, while the cable guide 7 and the exit 8 maintain the segments which lie outside the cable guide 7 and the exit 8, i.e., the outer segments of the cable 4, in substantially the original positions of such segments of the cable 4. If a first end 5 of the cable 4 is anchored, such outward rotation of the lever 1 draws a second end 6 of the cable 4 longitudinally closer to the Transversely Moving Cable Control. Even, however, if the first end 5 of the cable 4 is not anchored, greater friction is encountered by the cable 4 within the lever 1 than within the cable guide 7 that is preferably rotatably attached to the base plate 2 so that generally only the second end 6 of the cable 4, and not the first end 5, is drawn closer to the Transversely Moving Cable Control. (As a practical matter, though, the first end 5 of the cable 4 is always anchored, either at the exit 8 for the cable 4 from the lever 1 or at some point farther from the exit 8 when used with a bicycle. And, in fact, the exit 8 could be eliminated and methods that are well known in the art could be used to adapt the lever for attachment of the first end 5 of the cable 4, such as simply enlarging the cable 4 just beyond the exit 8 outside the lever 1, as illustrated in FIG. 4.)

Similarly, as the lever 1 is allowed to rotate into the base plate 2, the cable 4 is moved transversely closer to the original path of the cable 4 so that the second end 6 of the cable 4 is allowed to move longitudinally farther from the Transversely Moving Cable Control.

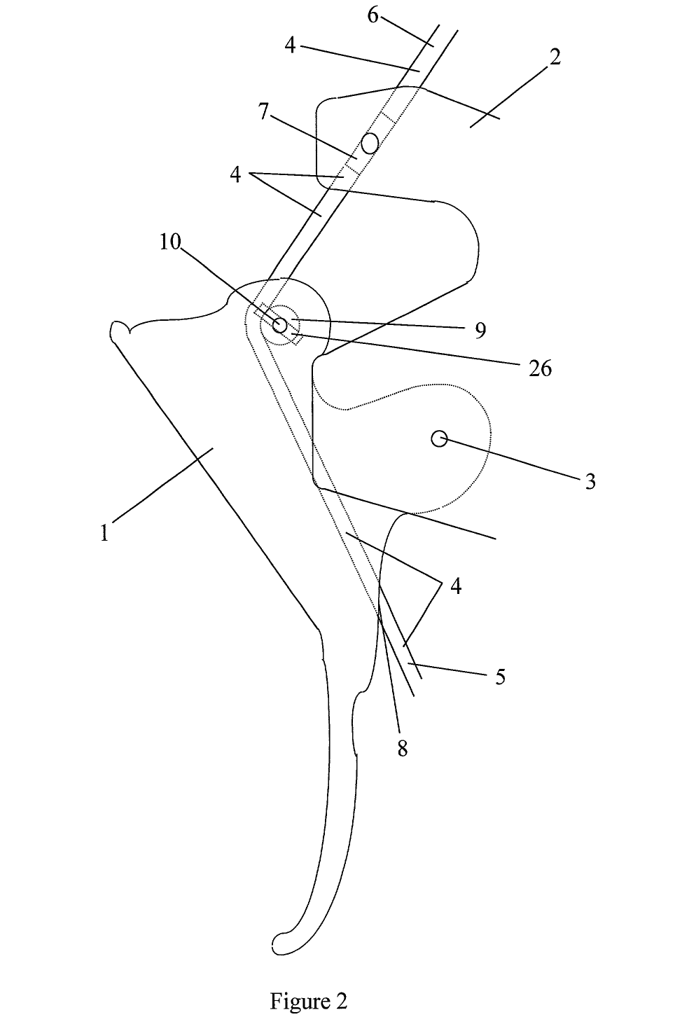

The distance which the cable 4 is moved—and, consequently, the mechanical advantage of the Transversely Moving Cable Control—can be increased either by having the pulley 9 removably attached to the lever 1 and replacing the original pulley 9 with a pulley 9 having a greater diameter than the original pulley 9 or by moving the pivot 10 of the pulley 9 farther from the pivot 3 within the channel 26, which in the preferred embodiment of the Transversely Moving Cable Control exists—as portrayed in FIG. 2, within the lever 1, so that when the lever 1 is rotated outward from the base plate 2, the pulley 9 will be farther from the original path of the cable 4. (The pivot 10 can be released, moved within the channel 26, and releasably fastened at another location within the channel 26 by using techniques which are well known in the art.)

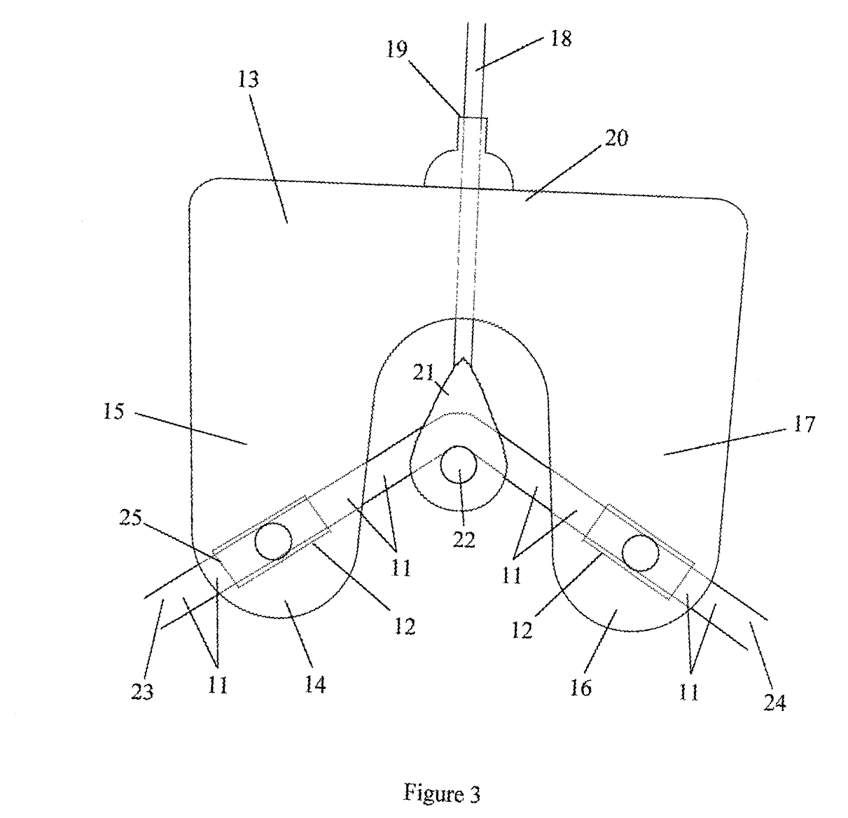

A second major embodiment of the Transversely Moving Cable Control is depicted in FIG. 3.

The cable 11 runs through two cable guides 12. The cable guides 12 are preferably pivotally mounted in a substantially U-shaped housing 13. One cable guide 12 is mounted, preferably pivotally, near a first end 14 of a first leg 15 of the U-shaped housing 13. The other cable guide 12 is mounted, preferably pivotally, near a first end 16 of a second leg 17 of the U-shaped housing 13. The cable guides 12 maintain the segments of the cable 11 which are outside the housing 13 and, therefore, outside the transversely moving cable control, in substantially the original positions of such segments of the cable 11. (The cable guides 12 are preferable but could be replaced by apertures near the first end 14 of the first leg 15 and near the first end 16 of a second leg 17.)

A secondary cable 18 passes through an aperture 19 beginning in the second end 20 of the U-shaped housing 13 and extends into the space between first leg 15 and second leg 17 of the U-shaped housing 13 before being attached to a block 21. The cable 11 passes through the block 21 between the point of attachment of the secondary cable 18 and a pulley 22. (Although pulleys are preferable since they reduce friction, any time a pulley is mentioned such pulley could be replaced by a stationary cylinder or other cable displacement device.)

As the block 21 is drawn by the secondary cable 18 toward the aperture 19, the portion of the cable 11 which is within the transversely moving cable control, specifically within the housing 13, is moved substantially transversely to the original path of the cable 11. Since both cable guides 12 are identical, both the first end 23 and the second end 24 of the cable 11 will be pulled longitudinally closer to the U-shaped housing 13. If only the first end 23 of the cable 11 is anchored, only the second end 24 of the cable 11 will be pulled longitudinally closer to the U-shaped housing 13. Just as with the first embodiment of the Transversely Moving Cable Control, the first end 23 of the cable can be anchored at a first end 25 of the cable guide 12 in the first leg 15 of the U-shaped housing 13 (or, if the cable guide 12 in the first leg 15 were eliminated, simply to the first leg 15, itself, at a point adapted for attachment of the cable 11) or at some point farther from the first end 25 of the cable guide 12.

Similarly, as the block 21 is allowed to move farther from the aperture 19, the cable 11 is permitted to move transversely closer to the original path of the cable 11, thereby permitting the unanchored end 24 (or unanchored ends 23, 24) of the cable 11 to move longitudinally farther from the U-shaped housing 13.

As long as the first end 23 and the second end 24 of the cable 11 are not parallel to one another, the larger the diameter of the pulley 22, the greater will be the movement of the end 24 or both ends 23, 24 of the cable 11 and, consequently, the greater will be the mechanical advantage of the Transversely Moving Cable Control.

I claim:

1. A transversely moving cable control, for controlling a cable, said cable having a portion within said transversely moving cable control, segments outside said transversely moving cable control, and original positions for all portions and segments of said cable before said transversely moving cable control has been activated, which comprises:
a means for transversely moving the portion of a cable which is within the transversely moving cable control to create a pulling force upon one or both ends of said cable; and
a means for maintaining the segments of said cable which are outside the transversely moving cable control substantially in the original positions of such segments.

2. A transversely moving cable control, which comprises:
a substantially U-shaped housing having a cable guide mounted near a first end of each leg of said housing to maintain the portion of the cable which lies outside the housing in substantially the original position of the cable; and
a means for transversely moving the portion of a cable which is within the transversely moving cable control to create a pulling force upon one or both ends of the cable.

3. The transversely moving cable control as recited in claim 2, wherein:
said housing contains an aperture through which a secondary cable passes before being attached to a block; and
the means for transversely moving the cable comprises a block having a pulley over which the cable passes so that as the block is drawn by the secondary cable toward the aperture in the housing, the cable is moved substantially transversely to the original path of the cable.

4. A transversely moving cable control, which comprises:
a substantially U-shaped housing having a first leg adapted for attachment of a cable and having a cable guide mounted near a first end of a second leg of said housing to maintain the portion of the cable which lies outside the housing in substantially the original position of the cable; and
a means for transversely moving the portion of a cable which is within the transversely moving cable control to create a pulling force upon one or both ends of the cable.

5. The transversely moving cable control as recited in claim 4, wherein:
said housing contains an aperture through which a secondary cable passes before being attached to a block; and
the means for transversely moving the cable comprises a block having a pulley over which the cable passes so that as the block is drawn by the secondary cable toward the aperture in the housing, the cable is moved substantially transversely to the original path of the cable.

6. A transversely moving cable control for controlling a cable, said cable having segments in original positions before said transversely moving cable control has been activated, which comprises:
a hollow base plate to maintain the segments of a cable which lie outside the transversely moving cable control in substantially the original positions of such segments of said cable; and
a means for transversely moving an intermediate portion of said cable to create a pulling force upon one or both ends of said cable and for maintaining a second segment of said cable which lies outside the transversely moving cable control in substantially the original position of such second segment of said cable.

7. The transversely moving cable control as recited in claim 6, wherein the means for transverse movement and maintaining said second segment in substantially the original position of such cable comprises:
a cable guide attached to said hollow base plate to maintain the segment of a cable which lies outside said hollow base plate beyond said cable guide in substantially the original position of the cable;
a lever rotatably attached to said hollow base plate;
a pulley, said pulley having a pivot, attached to said lever across which pulley the cable runs so that when the lever is rotated away from said base plate, the pulley exerts a transverse force on the cable which causes the cable to move in a transverse direction creating said pulling force on one or both ends of the cable; and
an exit aperture in said lever to maintain the segment of the cable which lies outside said hollow base plate beyond said exit aperture in substantially the original position of the cable.

8. The transversely moving cable control as recited in claim 7, wherein:
said pulley is removably attached to said lever.

9. The transversely moving cable control as recited in claim 7, further comprising:
a channel in the lever within which the pivot of said pulley can be releasably fastened, released, moved, and releasably fastened again.

10. A transversely moving cable control for controlling a cable, said cable having segments in original positions before said transversely moving cable control has been activated and said cable having a first end, which comprises:
a hollow base plate to maintain the segments of a cable which lie outside the transversely moving cable control in substantially the original positions of such segments of said cable; and
a means for transversely moving an intermediate portion of said cable to create a pulling force upon one or both ends of said cable, said means for transverse movement being adapted for attachment of the first end of said cable.

11. The transversely moving cable control as recited in claim 10, wherein the means for transverse movement adapted for attachment of the first end of the cable comprises:
a cable guide attached to said hollow base plate to maintain the segment of a cable which lies outside said hollow base plate beyond said cable guide in substantially the original position of the cable;
a lever adapted for attachment of the first end of the cable and rotatably attached to said hollow base plate; and
a pulley, said pulley having a pivot, attached to said lever across which pulley the cable runs so that when the lever is rotated away from said base plate, the pulley exerts a transverse force on the cable which causes the cable to move in a transverse direction creating said pulling force on one or both ends of the cable.

12. The transversely moving cable control as recited in claim 11, wherein:
said pulley is removably attached to said lever.

13. The transversely moving cable control as recited in claim 11, further comprising:
a channel in the lever within which the pivot of said pulley can be releasably fastened, released, moved, and releasably fastened again.

14. A process for exerting a control force at one or more ends of a cable, said cable having an intermediate portion and outer segments in original positions before said process commences, which comprises:
transversely moving an intermediate portion of said cable to create a pulling force upon one or both ends of said cable; and
simultaneously maintaining the outer segments of said cable substantially in the original positions of such segments.
